(19) United States
(12) Patent Application Publication
(10) Pub. No.: US 2026/0014935 A1
(43) Pub. Date: Jan. 15, 2026

(54) Attachment system for connecting a step to a vehicle

(71) Applicant: Integrity Auto Group Inc., Westminster, MD (US)

(72) Inventor: Tyler S. IVY, Hanover, PA (US)

(73) Assignee: Integrity Auto Group Inc., Westminster, MD (US)

(21) Appl. No.: 19/256,369

(22) Filed: Jul. 1, 2025

Related U.S. Application Data
(60) Provisional application No. 63/671,198, filed on Jul. 13, 2024.

(51) Int. Cl. B60R 3/00

(52) U.S. Cl. CPC B60R 3/007

(57) ABSTRACT

An attachment system for connecting a step to a vehicle includes the step, a mounting bracket, and a brace. The mounting bracket being connected to a step upper surface and/or a step lower surface along at least a portion of a step interior edge and including a central plate, a first hook attached to and extending from a central plate first end, and a second hook attached to and extending from a central plate second end. The brace being attached to and extending from the central plate between the central plate first end and the central plate second end and including a first member and a second member. The second member being disposed within a slot in a second longitudinal plate of the first member. The first hook and the second hook each independently being configured to connect to a tubular portion of the vehicle while the brace is configured to connect to a threaded hole in the vehicle by passing a brace fastener through a first plate attachment hole and into the threaded hole.

### CROSS REFERENCES AND PRIORITIES

This Application claims priority from U.S. Provisional Application No. 63/671,198 filed on Jul. 13, 2024, the teachings of which are incorporated by reference herein in their entirety.

### BACKGROUND

Many vehicles, particularly certain light trucks and full-sized sport utility vehicles, have large wheels and tires and/or long suspension systems which lead to a higher vehicle ride height. As a result, persons entering the vehicle have to step up or down a greater distance to enter or exit the vehicle. This can be difficult for individuals—in particular those who are elderly or who have physical disabilities which limit their movement.

Many solutions have been proposed to improve the ability of individuals to enter and exit vehicles having higher vehicle ride heights. The most common of which are steps attached at or near the vehicle's lower rocker panel(s) below the door opening(s). When attached to the vehicle, the step provides a lower height surface to assist individuals entering and exiting the vehicle.

Typical vehicle steps often include complex mounting systems which require individuals to physically modify their vehicle—such as by drilling holes into the vehicle chassis, cutting away sections of the vehicle, and/or removing factory bolt-on vehicle components—in order to install the vehicle step. This process can be time and labor intensive, can negatively impact vehicle safety by weakening the vehicle's structural integrity, and can result in an installed vehicle step which is not aesthetically pleasing.

The need exists, therefore, for an improved vehicle step and attachment system for connecting a step to a vehicle which is easy to install, requires minimal or no permanent physical modifications to the existing vehicle components, and is aesthetically pleasing.

### SUMMARY

Described herein is an attachment system for connecting a step to a vehicle. The attachment system includes the step, a mounting bracket, and a brace. The step has a step upper surface, a step lower surface, and a step interior edge. The mounting bracket is connected to the step upper surface and/or the step lower surface along at least a portion of the step interior edge.

The mounting bracket includes a central plate, a first hook, and a second hook. The central plate has a central plate first end and a central plate second end opposite the central plate first end. The first hook is attached to and extends from the central plate first end. The second hook is attached to and extends from the central plate second end. The brace is attached to and extends from the central plate between the central plate first end and the central plate second end.

The brace includes a first member and a second member. The first member has a first longitudinal plate attached to and forming a first angle relative to a second longitudinal plate. The first angle has a first angle measurement of about 90°. At least one first plate attachment hole passes through the first longitudinal plate. A slot extends from a second longitudinal plate terminal end through at least a portion of the first longitudinal plate. The second member is disposed within the slot and attached to the first member. A second angle formed between a second longitudinal plate lower surface and the second member has a second angle measurement of about 90°. A third angle formed between a second longitudinal plate upper surface and the second member has a third angle measurement of about 90°.

The first hook and the second hook are each independently configured to connect to a tubular portion of the vehicle. The brace is configured to connect to a threaded hole in the vehicle by passing a brace fastener through the first plate attachment hole and into the threaded hole.

In some embodiments, the central plate may include a central plate assembly. In some such embodiments, the central plate assembly may include a first vertical plate, a second vertical plate, a third vertical plate, a fourth vertical plate, a fifth vertical plate, and a first horizontal plate.

The first vertical plate, when present, may have a first vertical plate terminal end, a first vertical plate proximal end, a first vertical plate upper edge, and a first vertical plate lower edge. The first vertical plate terminal end, first vertical plate proximal end, first vertical plate upper edge, and first vertical plate lower edge define a first vertical plate plane having a first vertical plate interior surface and a first vertical plate exterior surface.

The second vertical plate, when present, may be attached to and extend from the first vertical plate terminal end. The second vertical plate may have a second vertical plate terminal end, a second vertical plate proximal end, a second vertical plate upper edge, and a second vertical plate lower edge. The second vertical plate terminal end, second vertical plate proximal end, second vertical plate upper edge, and second vertical plate lower edge define a second vertical plate plane having a second vertical plate interior surface and a second vertical plate exterior surface. A fourth angle formed between the first vertical plate interior surface and the second vertical plate interior surface may have a fourth measurement in a range of between 50° and 70°.

The third vertical plate, when present, may be attached to and extend from the first vertical plate proximal end. The third vertical plate may have a third vertical plate terminal end, a third vertical plate proximal end, a third vertical plate upper edge, and a third vertical plate lower edge. The third vertical plate terminal end, third vertical plate proximal end, third vertical plate upper edge, and third vertical plate lower edge define a third vertical plate plane having a third vertical plate interior surface and a third vertical plate exterior surface. A fifth angle formed between the first vertical plate interior surface and the third vertical plate interior surface may have a fifth measurement in a range of between 50° and 70°.

The fourth vertical plate, when present, may be attached to and extend from the second vertical plate terminal end. The fourth vertical plate may have a fourth vertical plate terminal end, a fourth vertical plate proximal end, a fourth vertical plate upper edge, and a fourth vertical plate lower edge. The fourth vertical plate terminal end, fourth vertical plate proximal end, fourth vertical plate upper edge, and fourth vertical plate lower edge define a fourth vertical plate plane having a fourth vertical plate interior surface and a fourth vertical plate exterior surface. A sixth angle formed between the second vertical plate interior surface and the fourth vertical plate interior surface may have a sixth measurement in a range of between 50° and 70°.

The fifth vertical plate, when present, may have a fifth vertical plate terminal end, a fifth vertical plate proximal end, a fifth vertical plate upper edge, and a fifth vertical plate lower edge. The fifth vertical plate terminal end, fifth vertical plate proximal end, fifth vertical plate upper edge, and fifth vertical plate lower edge define a fifth vertical plate plane having a fifth vertical plate interior surface and a fifth vertical plate exterior surface. A fourth seventh angle formed between the third vertical plate interior surface and the fifth vertical plate interior surface may have a seventh measurement in a range of between 50° and 70°.

The first horizontal plate may, when present, be attached to and extend inwardly from the first vertical plate lower edge. The first horizontal plate may have a first horizontal plate upper surface and a first horizontal plate lower surface. An eighth angle formed between the first vertical plate interior surface and the first horizontal plate upper surface may have an eighth angle measurement of about 90°.

In some embodiments, the central plate assembly may further include a first mounting tab having a first mounting tab hole passing therethrough. The first mounting tab may be attached to and extend outwardly from the first vertical plate upper edge, the second vertical plate upper edge, or the fourth vertical plate upper edge. The central plate assembly may also include a second mounting tab having a second mounting tab hole passing therethrough. The second mounting tab may be attached to and extend outwardly from the first vertical plate upper edge, the third vertical plate upper edge, or the fifth vertical plate upper edge.

In certain embodiments of the central plate assembly, the first hook may be attached to and extend from the fourth vertical plate upper edge. In some such embodiments, the second hook may be attached to and extend upwardly from the fifth vertical plate upper edge.

In some embodiments, the step may include at least a first step mounting hole and a second step mounting hole. The central plate assembly may be connected to the step lower surface by passing a first fastener through the first step mounting hole and into the first mounting tab hole, and passing a second fastener through the second step mounting hole and into the second mounting tab hole.

In certain embodiments, the central plate may include a plurality of central plate holes disposed along a central plate length spanning from the central plate first end to the central plate second end. In some such embodiments, the second longitudinal plate may include at least one second longitudinal plate hole at the second longitudinal plate terminal end. In such embodiments, the brace may be adjustably connectable to the mounting bracket by passing a third fastener through the at least one second longitudinal plate hole and into a central plate hole of the plurality of central plate holes.

In some embodiments which include a central plate assembly, the first horizontal plate may include a plurality of first horizontal plate holes disposed along a length of the first horizontal plate. In certain such embodiments, the second longitudinal plate may include at least one second longitudinal plate hole at the second longitudinal plate terminal end. In such embodiments, the brace may be adjustably connectable to the mounting bracket by passing a third fastener through the at least one second longitudinal plate hole and into a first horizontal plate hole of the plurality of first horizontal plate holes.

In certain embodiments, the step may include a tube, a platform, and a lip. When present, the tube may have a tube proximal end, a tube terminal end, a first inward bend between the tube proximal end and the tube terminal end, and a second tube inward bend between the tube first inward bend and the tube terminal end. The tube first inward bend may have a tube first inward bend angle in a range of between 50° and 70°. The tube second inward bend may have a tube second inward bend angle in a range of between 50° and 70°. When present, the platform may have a platform proximal end, a platform terminal end, a platform exterior edge, and a platform interior edge defining a platform plane having a platform upper surface and a platform lower surface. When present, the lip may be attached to and extend upwardly from the platform interior edge. In such embodiments, at least a portion of each of the platform proximal end, the platform terminal end, and the platform exterior edge may abut against the tube. In certain such embodiments of the step, the platform exterior edge may have a platform exterior edge dimension which is less than a platform interior edge dimension of the platform interior edge.

In some embodiments, the step may further include a first step tab and a second step tab. The first step tab may be attached to and extend inwardly from a first position on the tube and may include a first step tab hole. The second step tab may be attached to and extend inwardly from a second position on the tube and may include a second step tab hole. In such embodiments, the platform may be connected to the tube by passing a fourth fastener through a first platform mounting hole and into the first step tab hole and by passing a fifth fastener through a second platform mounting hole and into the second step tab hole.

In certain embodiments, the tube proximal end may be connected to the central plate first end. In some embodiments, the tube terminal end may be connected to the central plate second end. In certain embodiments, a lip proximal end may be connected to the central plate first end. In some embodiments, a lip terminal end may be connected to the central plate second end.

### BRIEF DESCRIPTION OF FIGURES

FIG. 1 illustrates an isometric top view of an attachment system for connecting a step to a vehicle.

FIG. 2 illustrates an isometric bottom view of an attachment system for connecting a step to a vehicle.

FIG. 3 illustrates an exploded isometric view of an attachment system for connecting a step to a vehicle.

FIG. 4 illustrates a top view of an attachment system for connecting a step to a vehicle.

FIG. 5 illustrates a bottom view of an attachment system for connecting a step to a vehicle.

FIG. 6 illustrates a front view of an attachment system for connecting a step to a vehicle.

FIG. 7 illustrates a rear view of an attachment system for connecting a step to a vehicle.

FIG. 8 illustrates an inner side view of an attachment system for connecting a step to a vehicle.

FIG. 9 illustrates an outer side view of an attachment system for connecting a step to a vehicle.

FIG. 10 illustrates an exploded isometric view of a mounting bracket and a brace.

FIG. 11 illustrates a front view of a step connected to a portion of a vehicle using the attachment system.

FIG. 12 illustrates a rear view of a step connected to a portion of a vehicle using the attachment system.

FIG. 13 illustrates a central cross section view of a step connected to a portion of a vehicle using the attachment system.

### DETAILED DESCRIPTION

Described herein is an attachment system for connecting a step to a vehicle. Reference is made to the Figures in which, unless otherwise noted, like numbers refer to like structures. As described herein, the following numbers refer to the following structures as noted in the Figures.
10 refers to an attachment system.
50 refers to a vehicle.
51 refers to a tubular portion (of the vehicle).
52 refers to a threaded hole (in the vehicle).
100 refers to a step.
101 refers to a first step mounting hole.
102 refers to a second step mounting hole.
110 refers to a step upper surface.
120 refers to a step lower surface.
130 refers to a step interior edge.
140 refers to a tube.
141 refers to a tube proximal end.
142 refers to a tube terminal end.
150 refers to a platform.
151 refers to a platform proximal end.
152 refers to a platform terminal end.
153 refers to a platform exterior edge.
154 refers to a platform interior edge.
155 refers to a platform upper surface.
156 refers to a platform lower surface.
157 refers to a first platform mounting hole.
158 refers to a second platform mounting hole.
160 refers to a lip.
161 refers to a lip proximal end.
162 refers to a lip terminal end.
170 refers to a first step tab.
171 refers to a first step tab hole.
180 refers to a second step tab.
181 refers to a second step tab hole.
200 refers to a mounting bracket.
201 refers to a first mounting tab.
202 refers to a first mounting tab hole.
203 refers to a second mounting tab.
204 refers to a second mounting tab hole.
205 refers to a first fastener.
206 refers to a second fastener.
207 refers to a central plate hole.
208 refers to a third fastener.
210 refers to a central plate.
211 refers to a central plate first end.
215 refers to a central plate assembly.
220 refers to a first hook.
230 refers to a second hook.
240 refers to a first vertical plate.
241 refers to a first vertical plate terminal end.
242 refers to a first vertical plate proximal end.
243 refers to a first vertical plate upper edge.
244 refers to a first vertical plate lower edge.
245 refers to a first vertical plate interior surface.
246 refers to a first vertical plate exterior surface.
250 refers to a second vertical plate.
251 refers to a second vertical plate terminal end.
252 refers to a second vertical plate proximal end.
253 refers to a second vertical plate upper edge.
254 refers to a second vertical plate lower edge.
255 refers to a second vertical plate interior surface.
256 refers to a second vertical plate exterior surface.
260 refers to a third vertical plate.
261 refers to a third vertical plate terminal end.
262 refers to a third vertical plate proximal end.
263 refers to a third vertical plate upper edge.
264 refers to a third vertical plate lower edge.
265 refers to a third vertical plate interior surface.
266 refers to a third vertical plate exterior surface.
270 refers to a fourth vertical plate.
271 refers to a fourth vertical plate terminal end.
272 refers to a fourth vertical plate proximal end.
273 refers to a fourth vertical plate upper edge.
274 refers to a fourth vertical plate lower edge.
275 refers to a fourth vertical plate interior surface.
276 refers to a fourth vertical plate exterior surface.
280 refers to a fifth vertical plate.
281 refers to a fifth vertical plate terminal end.
282 refers to a fifth vertical plate proximal end.
283 refers to a fifth vertical plate upper edge.
284 refers to a fifth vertical plate lower edge.
285 refers to a fifth vertical plate interior surface.
286 refers to a fifth vertical plate exterior surface.
290 refers to a first horizontal plate.
291 refers to a first horizontal plate upper surface.
292 refers to a first horizontal plate lower surface.
293 refers to a first horizontal plate hole.
300 refers to a brace.
310 refers to a first member.
311 refers to a first longitudinal plate.
312 refers to a second longitudinal plate.
313 refers to a first plate attachment hole.
314 refers to a slot.
315 refers to a second longitudinal plate terminal end.
316 refers to a second longitudinal plate lower surface.
317 refers to a second longitudinal plate upper surface.
318 refers to a second longitudinal plate hole.
320 refers to a second member.
330 refers to a brace fastener.

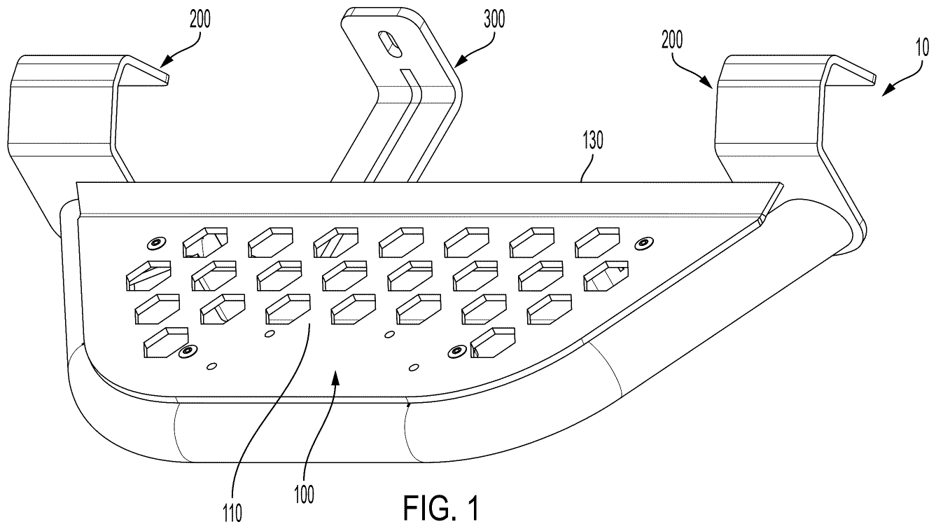

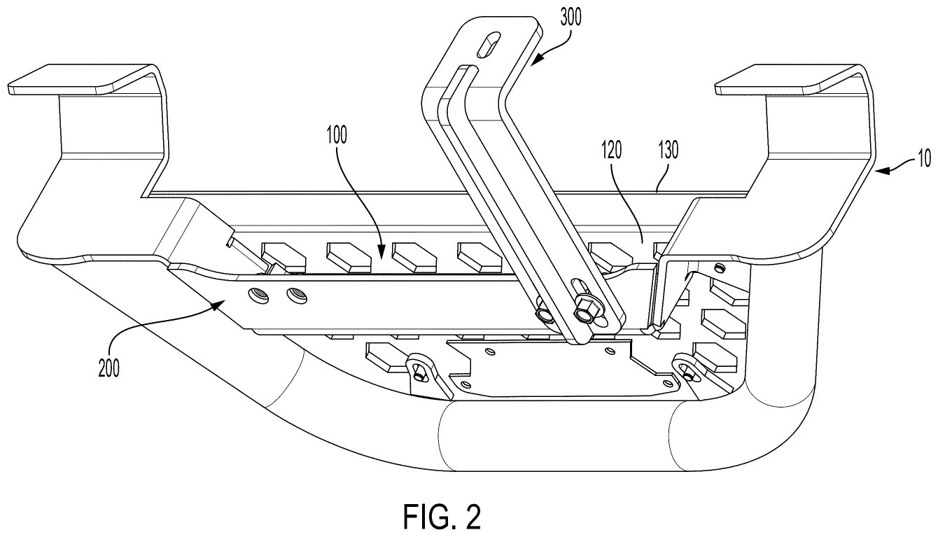

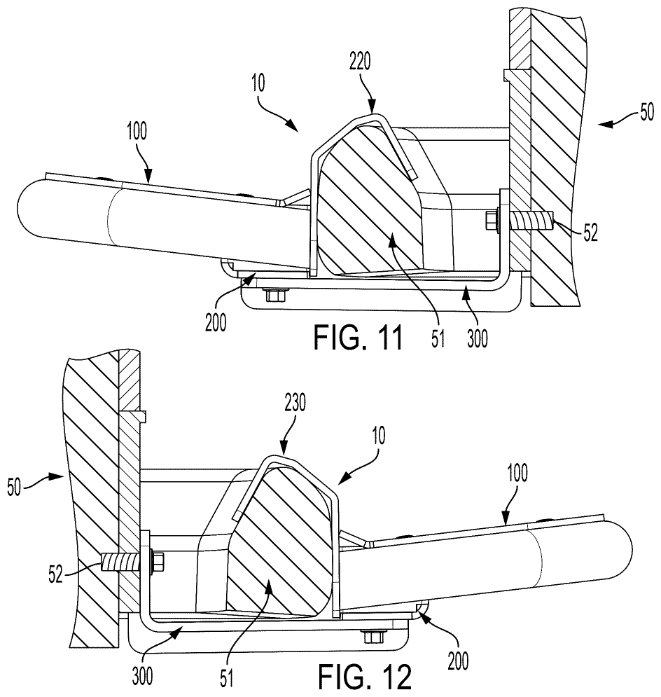

FIG. 1 and FIG. 2 illustrate an exemplary embodiment of an attachment system (10) for connecting a step (100) to a vehicle ((50) as shown in FIG. 11) with FIG. 1 illustrating a top isometric view and FIG. 2 illustrating a bottom isometric view. As shown in FIG. 1 and FIG. 2, the attachment system includes the step which has a step upper surface (110) and a step lower surface (120), a mounting bracket (200), and a brace (300).

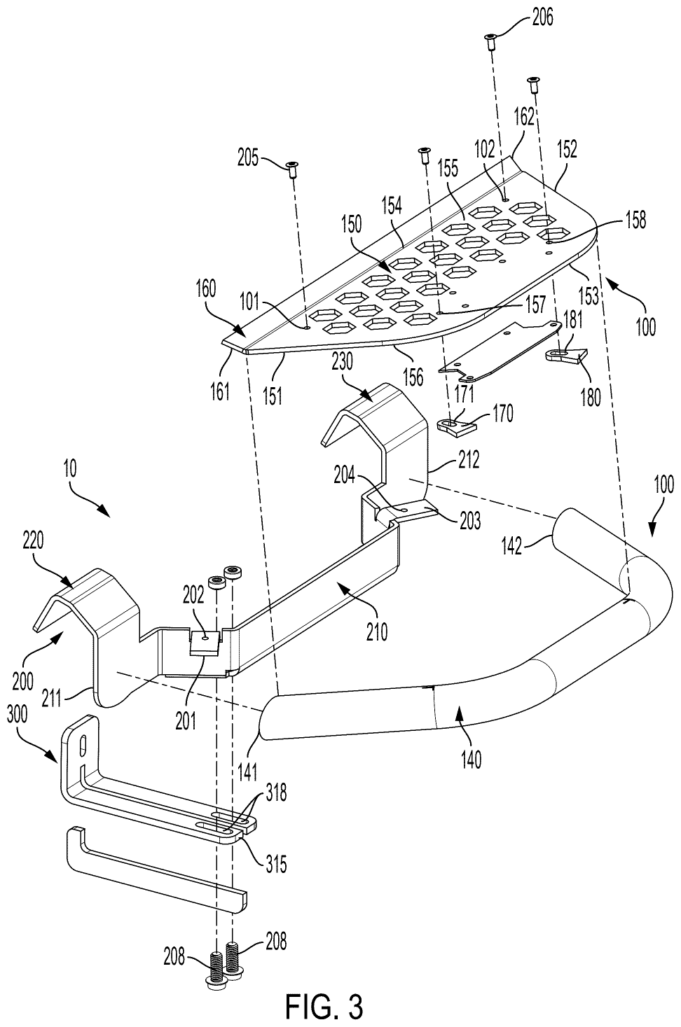

FIG. 3 illustrates an exploded isometric view of an exemplary embodiment of an attachment system (10) for connecting a step (100) to a vehicle ((50) as shown in FIG. 11) including additional details of the step, a mounting bracket (200), and a brace (300). As shown in FIG. 3, the mounting bracket includes a central plate (210) having a central plate first end (211) and a central plate second end (212) which is opposite the second plate first end. Attached to and extending from the central plate first end is a first hook (220). Similarly, attached to and extending from the central plate second end is a second hook (230). The attachment between the central plate first end and the first hook, and the central plate second end and the second hook, may each independently take many forms. Non-limiting examples of such connections include permanent connections such as manufacturing the central plate and the first hook and/or the second hook of a single integral piece of material which may be bent to form, or may include welding one or both of the hooks to the central plate. Other non-limiting examples of such a connection include nonpermanent connections such as fasteners—including, but not limited to, bolts (with or without nuts), screws, rivets, clamps, and the like—which connect one or both of the hooks to the central plate.

A first mounting tab (201) may be attached to and extend outwardly from the central plate (210) at or about the central plate first end (211). When present, the first mounting tab provides a surface to which the step (100) may connect to the mounting bracket (200). The connection between the step and the first mounting tab may take many forms. In some embodiments, the first mounting tab may include a first mounting tab hole (202) passing therethrough such that a first fastener (205)—such as a bolt (with or without a nut), a screw, a rivet, or the like—may pass through a first step mounting hole (101) in the step and into the first mounting tab hole (or vice versa). Alternatively, the step may be connected to the first mounting tab by welding a surface of the step to the first mounting tab.

Similarly, a second mounting tab (203) may be attached to and extend outwardly from the central plate (210) at or about the central plate second end (212). When present, the second mounting tab provides a surface to which the step (100) may connect to the mounting bracket (200). The connection between the step and the second mounting tab may take many forms. In some embodiments, the second mounting tab may include a second mounting tab hole (204) passing therethrough such that a second fastener (206)—such as a bolt (with or without a nut), a screw, a rivet, or the like—may pass through a second step mounting hole (102) in the step and into the second mounting tab hole (or vice versa). Alternatively, the step may be connected to the second mounting tab by welding a surface of the step to the second mounting tab.

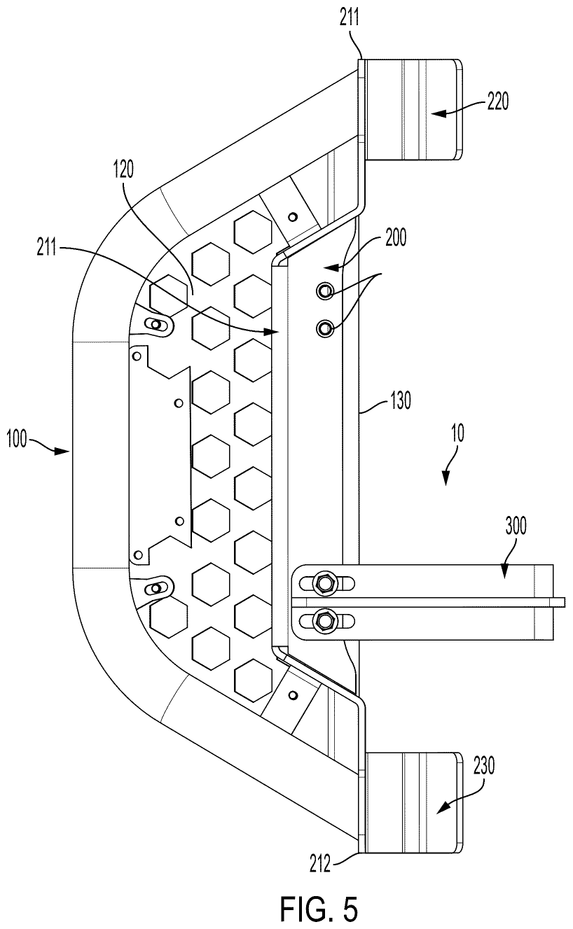

The central plate may also include a plurality of central plate holes ((207) as shown in FIG. 5) disposed along a central plate length spanning from the central plate first end to the central plate second end. These central plate holes serve as an attachment point for connecting the mounting bracket (200) to the brace (300). The mounting bracket may connect to the brace by passing a third fastener (208)—such as a bolt (with or without a nut), a screw, a rivet, or the like—through a second longitudinal plate hole (318) in a second longitudinal plate terminal end (315) of the brace and into one of the central plate holes of the plurality of central plate holes. In some embodiments, such as that shown in FIG. 3, the second longitudinal plate terminal end may include more than one second longitudinal plate hole with individual fasteners configured to pass through each of the second longitudinal plate holes and into separate central plate holes of the plurality of central plate holes. The plurality of central plate holes will preferably include a number of central plate holes which is greater than the number of second longitudinal plate holes such that the position of the brace may be adjusted along the length of the central plate. Alternatively, the mounting bracket may connect to the brace by welding the second longitudinal plate terminal end to the central plate (210).

FIG. 3 also illustrates additional details of an exemplary embodiment of the step (100). As shown in FIG. 3, the step may include a tube (140), a platform (150), and a lip (160). When present, the tube will have a tube proximal end (141) and a tube terminal end (142). A tube first inward bend may be present between the tube proximal end and the tube terminal end. Preferably, the tube first inward bend—when present—will have a tube first inward bend angle in a range of between 50° and 70°. Similarly, a tube second inward bend may be present between the tube first inward bend and the tube terminal end. Preferably, the tube second inward bend—when present—will have a tube second inward bend angle in a range of between 50° and 70°. The tube inward bends—in combination with one another—provide for a tube having a substantially “C” shaped profile as shown in FIG. 3.

The platform (150)—when present—includes a platform proximal end (151), a platform terminal end (152), a platform exterior edge (153), and a platform interior edge (154) defining a platform plane having a platform upper surface (155) and a platform lower surface (156). As shown in the Figures, the platform exterior edge has a platform exterior edge dimension which may be less than a platform interior edge dimension of the platform interior edge giving the platform a substantially trapezoidal shape.

In the embodiment of the step (100) shown in FIG. 3, the lip (160) is attached to and extends upwardly from the platform interior edge (154). The lip, when present, includes a lip proximal end (161) and a lip terminal end (162). In assembled form, the lip proximal end will connect to or abut against the central plate first end (211) while the lip terminal end will connect to or abut against the central plate second end (212). If one (or both) of the lip ends connects to a central plate end, the connection may be a permanent connection such as welding, or may be a non-permanent connection such as that achieved by a fastener—such as a bolt (with or without a nut), a screw, a rivet, a clamp, or the like. Preferably the attachment between the lip and the platform interior edge will be a permanent connection such as by manufacturing the platform and the lip of a single integral piece of material which may be bent to form, or by welding the lip to the platform interior edge.

Once assembled as shown in the Figures, a portion of each of the platform proximal end (151), the platform terminal end (152), and the platform exterior edge (153) may abut against the tube. In some embodiments, one or more of the platform edges abutting against the tube may be connected to the tube such as by welding or by way of a fastener.

In certain embodiments, the step (100) may also include a first step tab (170) attached to and extending inwardly from a first position on the tube (140). Preferably, when present, the first step tab will be welded to the tube. The first step tab may include a first step tab hole (171) passing therethrough. The platform (150) may then be connected to the tube by passing a fourth fastener—such as a bolt (with or without a nut), a screw, a rivet, or the like—through a first platform mounting hole (157) and into the first step tab hole (or vice versa).

Similarly, some embodiments of the step (100) may also include a second step tab (180) attached to and extending inwardly from a second position on the tube (140). Preferably, when present, the second step tab will be welded to the tube. The second step tab may include a second step tab hole (181) passing therethrough. The platform (150) may then be connected to the tube by passing a fifth fastener—such as a bolt (with or without a nut), a screw, a rivet, or the like—through a second platform mounting hole (158) and into the second step tab hole (or vice versa).

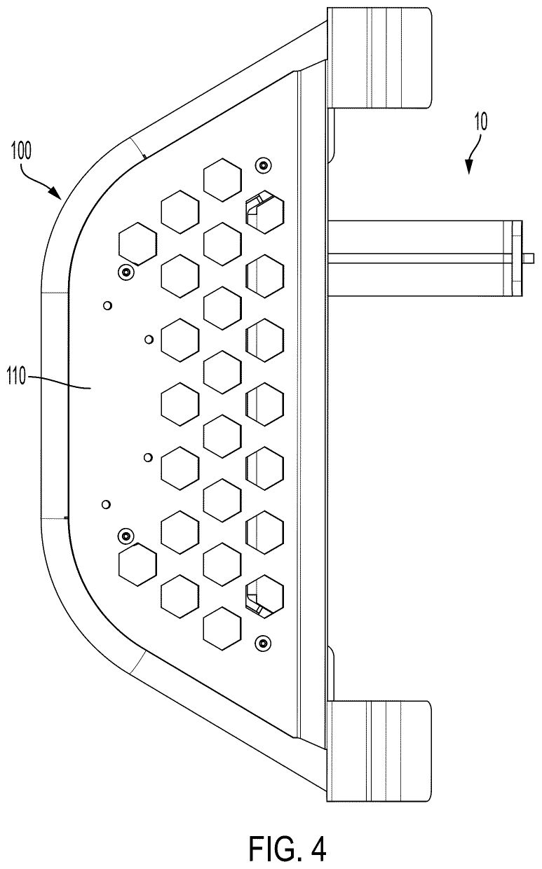

FIG. 4 and FIG. 5 illustrate top and bottom views respectively of an exemplary embodiment of an attachment system (10) for connecting a step (100) to a vehicle ((50) as shown in FIG. 11). Included in FIG. 4 and FIG. 5 are additional details of the step (100) including the step upper surface (110) and the step lower surface (120). In some embodiments—such as those shown in FIG. 4 and FIG. 5—the step may include a surface pattern providing for increased grip on the step and/or decorative embellishments. In the embodiment shown in FIG. 4 and FIG. 5, the surface pattern includes a plurality of through holes—each of which has a substantially hexagonal shape. However, other embodiments of surface patterns may exist. Non-limiting examples of such surface patterns include a plurality of through holes, a plurality of blind holes—preferably extending into the step upper surface, a plurality of protrusions—preferably extending upwardly from the step upper surface, and combinations thereof. These surface patterns may have any number of different sizes, shapes, and profiles.

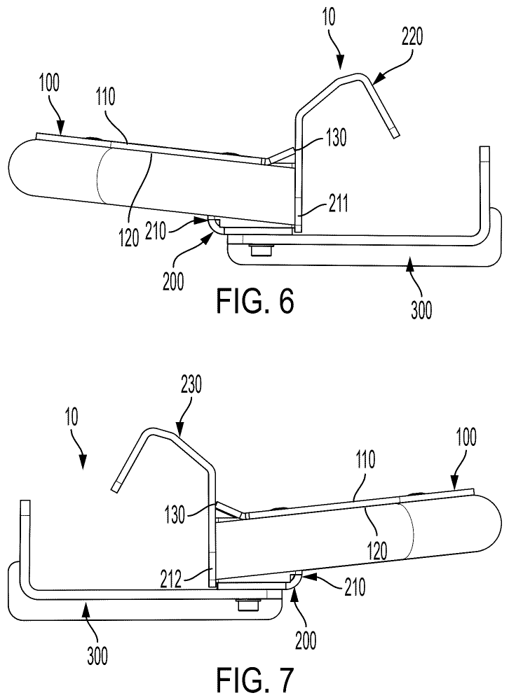

FIG. 6 and FIG. 7 illustrate front and rear views respectively of an exemplary embodiment of an attachment system (10) for connecting a step (100) to a vehicle ((50) as shown in FIG. 11). Included in FIG. 6 and FIG. 7 are additional details of the step (100), the mounting bracket (200), and the brace (300).

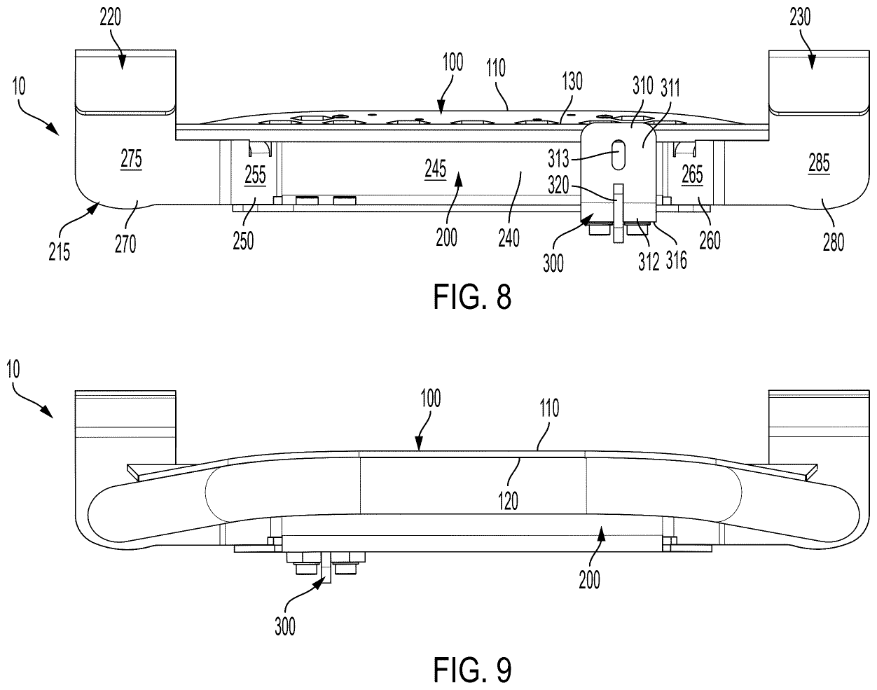

FIG. 8 illustrates an inner side view of an exemplary embodiment of an attachment system (10) for connecting a step (100) to a vehicle ((50) as shown in FIG. 11) including additional features of the mounting bracket (200) and the brace (300). In the embodiment shown in FIG. 8, the central plate (210) of the mounting bracket may be thought of as a central plate assembly (215). The central plate assembly including a first vertical plate (240) having a first vertical plate interior surface (245), a second vertical plate (250) having a second vertical plate interior surface (255), a third vertical plate (260) having a third vertical plate interior surface (265), a fourth vertical plate (270) having a fourth vertical plate interior surface (275), and a fifth vertical plate (280) having a fifth vertical plate interior surface (285). The central plate assembly may be manufactured in many different ways. In some embodiments, the various plates which make up the central plate assembly may be permanently connected to one another such as by welding or by manufacturing the plates from a single integral piece of material which is bent to shape. In other embodiments, the various plates which make up the central plate assembly may be removably connected to one another by one or more fasteners such as bolt (with or without nuts), screws, rivets, clamps, or the like.

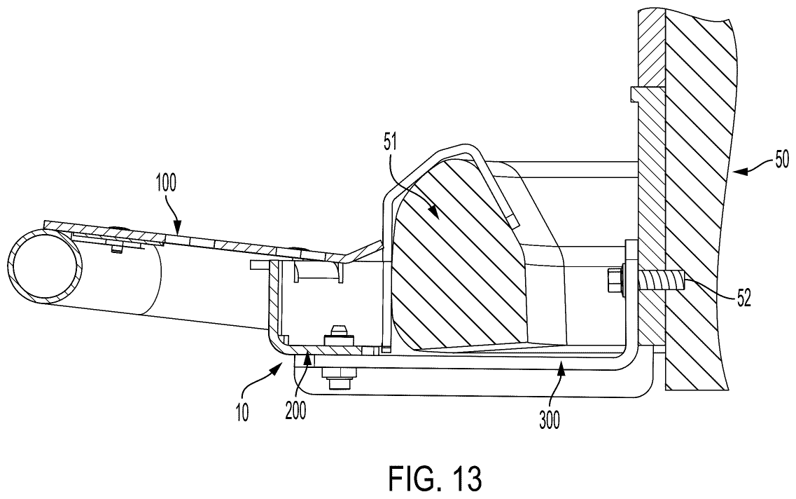

As shown in FIG. 8, the brace (300) may include a first member (310) and a second member (320). In such configurations, the first member may include a first longitudinal plate (311) attached to and forming a first angle relative to a second longitudinal plate (312). The first angle will have a first angle measurement of equal to or about 90°. Preferably, the first longitudinal plate will include at least one first plate attachment hole (313) which serves as a mounting point for connecting the brace to the vehicle ((50) as shown in FIG. 13) by passing a brace fastener ((330) as shown in FIG. 13) through the first plate attachment hole and into a threaded hole ((52) as shown in FIG. 13) in the vehicle.

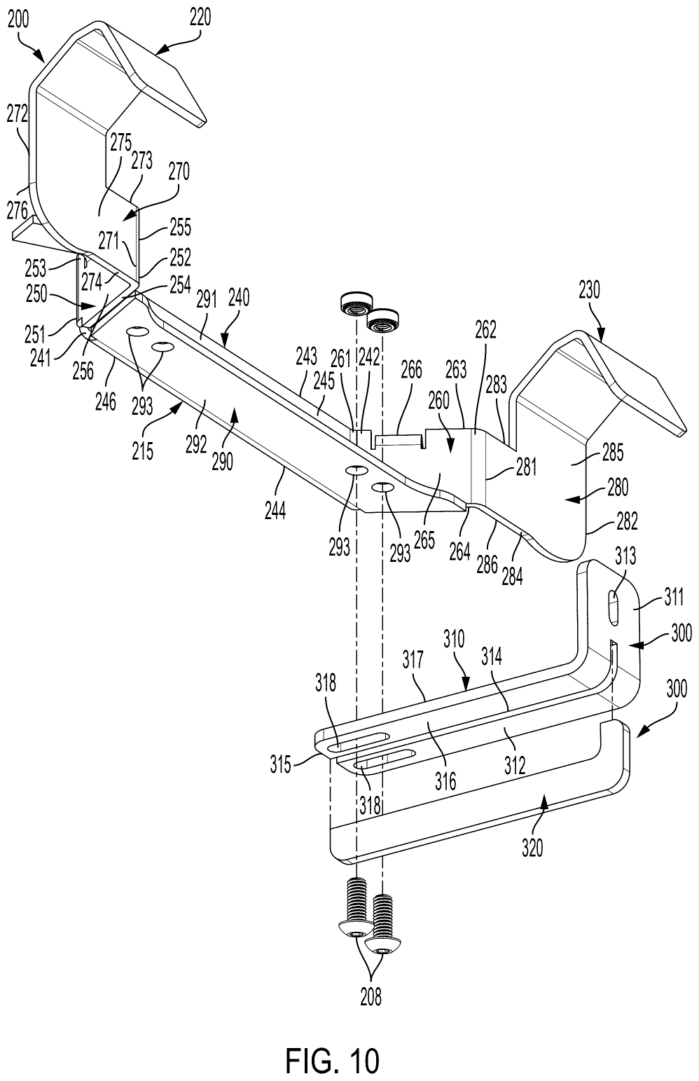

The second member (320) may be disposed within a slot ((314) as shown in FIG. 10) which extends from a second longitudinal plate terminal end ((315) as shown in FIG. 10) through at least a portion of the first longitudinal plate (311). The second member may then be attached to the first member by welding along at least a portion of the length of an interface between the first member and the second member. As such, a second angle will be formed between a second longitudinal plate lower surface (316) and the second member. The second angle will have a second angle measurement of equal to or about 90°. Similarly, a third angle will be formed between a second longitudinal plate upper surface ((317) as shown in FIG. 10) and the second member. The third angle will have a third angle measurement of equal to or about 90°.

FIG. 9 illustrates an outer side view of an exemplary embodiment of an attachment system (10) for connecting a step (100) to a vehicle ((50) as shown in FIG. 11). Included in FIG. 9 are additional details of the step (100), the mounting bracket (200), and the brace (300).

FIG. 10 illustrates an exploded isometric view of an exemplary embodiment of a mounting bracket (200) and a brace (300) for an attachment system (10) for connecting a step (100) to a vehicle ((50) as shown in FIG. 11). In the embodiment shown in FIG. 10, the central plate (210) of the mounting bracket is in the form of a central plate assembly (215) of similar construction to that which is illustrated in FIG. 8.

Details of the central plate assembly (215) may be seen in FIG. 11. As shown in FIG. 11, the first vertical plate (240) includes a first vertical plate terminal end (241), a first vertical plate proximal end (242) opposite the first vertical plate terminal end, a first vertical plate upper edge (243), and a first vertical plate lower edge (244) opposite the first vertical plate upper edge. The first vertical plate terminal end, first vertical plate proximal end, first vertical plate upper edge, and first vertical plate lower edge define a first vertical plate plane having a first vertical plate interior surface (245) and a first vertical plate exterior surface (246).

Attached to and extending from the first vertical plate terminal end (241) is the second vertical plate (250). The second vertical plate includes a second vertical plate terminal end (251), a second vertical plate proximal end (252) opposite the second vertical plate terminal end, a second vertical plate upper edge (253), and a second vertical plate lower edge (254) opposite the second vertical plate upper edge. The second vertical plate terminal end, second vertical plate proximal end, second vertical plate upper edge, and second vertical plate lower edge define a second vertical plate plane having a second vertical plate interior surface (255) and a second vertical plate exterior surface (256). As shown in FIG. 10, a fourth angle is formed between the first vertical plate interior surface and the second vertical plate interior surface. The fourth angle may have a measurement in a range of between 50° and 70°.

Attached to and extending from the first vertical plate proximal end (242) is the third vertical plate (260). The third vertical plate includes a third vertical plate terminal end (261), a third vertical plate proximal end (262) opposite the third vertical plate terminal end, a third vertical plate upper edge (263), and a third vertical plate lower edge (264) opposite the third vertical plate upper edge. The third vertical plate terminal end, third vertical plate proximal end, third vertical plate upper edge, and third vertical plate lower edge define a third vertical plate plane having a third vertical plate interior surface (265) and a third vertical plate exterior surface (266). As shown in FIG. 10, a fifth angle is formed between the first vertical plate interior surface and the third vertical plate interior surface. The fifth angle may have a measurement in a range of between 50° and 70°.

Attached to and extending from the second vertical plate terminal end (251) is the fourth vertical plate (270). The fourth vertical plate includes a fourth vertical plate terminal end (271), a fourth vertical plate proximal end (272) opposite the fourth vertical plate terminal end, a fourth vertical plate upper edge (273), and a fourth vertical plate lower edge (274) opposite the fourth vertical plate upper edge. The fourth vertical plate terminal end, fourth vertical plate proximal end, fourth vertical plate upper edge, and fourth vertical plate lower edge define a fourth vertical plate plane having a fourth vertical plate interior surface (275) and a fourth vertical plate exterior surface (276). As shown in FIG. 10, a sixth angle is formed between the second vertical plate exterior surface and the fourth vertical plate exterior surface. The sixth angle may have a measurement in a range of between 50° and 70°.

Attached to and extending from the third vertical plate terminal end (261) is the fifth vertical plate (280). The fifth vertical plate includes a fifth vertical plate terminal end (281), a fifth vertical plate proximal end (282) opposite the fifth vertical plate terminal end, a fifth vertical plate upper edge (283), and a fifth vertical plate lower edge (284) opposite the fifth vertical plate upper edge. The fifth vertical plate terminal end, fifth vertical plate proximal end, fifth vertical plate upper edge, and fifth vertical plate lower edge define a fifth vertical plate plane having a fifth vertical plate interior surface (285) and a fifth vertical plate exterior surface (286). As shown in FIG. 10, a seventh angle is formed between the third vertical plate exterior surface and the fifth vertical plate exterior surface. The seventh angle may have a measurement in a range of between 50° and 70°. Preferably, the fourth vertical plate interior surface (275) and the fifth vertical plate interior surface will be substantially aligned with and parallel to one another.

FIG. 10 also illustrates the central plate assembly (215) including a first horizontal plate (290). The first horizontal plate may be attached to and extend inwardly from the first vertical plate lower edge (244). The first horizontal plate includes a first horizontal plate upper surface (291) and a first horizontal plate lower surface (292). As shown in FIG. 10, an eighth angle is formed between the first vertical plate interior surface and the first horizontal plate upper surface. The eighth angle may have a measurement of equal to or about 90°.

In some embodiments, such as that shown in FIG. 10, the first horizontal plate (290) may include a plurality of first horizontal plate holes (293) disposed along a length of the first horizontal plate. The first horizontal plate holes may be utilized to adjustably connect the brace (300) to the mounting bracket (200) as described herein with reference to FIG. 3 by passing one or more third fastener(s) (208) through one or more second longitudinal plate hole(s) (318) and into at least one of the first horizontal plate hole of the plurality of first horizontal plate holes.

In the embodiment shown in FIG. 10, a first mounting tab ((201) as shown in FIG. 3) may be attached to and extend outwardly from at least one of the first vertical plate upper edge (243), the second vertical plate upper edge (253), or the fourth vertical plate upper edge (273). When present, the first mounting tab provides a surface to which the step ((100) as shown in FIG. 3) may connect to the mounting bracket (200). The connection between the step and the first mounting tab may take many forms. In some embodiments, the first mounting tab may include a first mounting tab hole ((202) as shown in FIG. 3) passing therethrough such that a first fastener ((205) as shown in FIG. 3)—such as a bolt (with or without a nut), a screw, a rivet, or the like—may pass through a first step mounting hole ((101) as shown in FIG. 3) in the step and into the first mounting tab hole (or vice versa). Alternatively, the step may be connected to the first mounting tab by welding a surface of the step to the first mounting tab.

Similarly, in the embodiment shown in FIG. 10, a second mounting tab ((203) as shown in FIG. 3) may be attached to and extend outwardly from at least one of the first vertical plate upper edge (243), the third vertical plate upper edge (263), or the fifth vertical plate upper edge (283). When present, the second mounting tab provides a surface to which the step ((100) as shown in FIG. 3) may connect to the mounting bracket (200). The connection between the step and the second mounting tab may take many forms. In some embodiments, the second mounting tab may include a second mounting tab hole ((204) as shown in FIG. 3) passing therethrough such that a second fastener ((206) as shown in FIG. 3)—such as a bolt (with or without a nut), a screw, a rivet, or the like—may pass through a second step mounting hole ((102) as shown in FIG. 3) in the step and into the second mounting tab hole (or vice versa). Alternatively, the step may be connected to the second mounting tab by welding a surface of the step to the second mounting tab.

As further shown in FIG. 10, the first hook (220) may be attached to and extend from the fourth vertical plate upper edge (273). Similarly, the second hook (230) may be attached to and extend from the fifth vertical plate upper edge (283). In some embodiments, first hook and/or the second hook may be permanently connected to their respective vertical plates such as by welding or by manufacturing the hook(s) and the vertical plate(s) from a single integral piece of material which is bent to shape. In other embodiments, the first hook and/or the second hook may be removably connected to their respective vertical plates by one or more fasteners such as bolt (with or without nuts), screws, rivets, clamps, or the like.

FIG. 11 through FIG. 13 illustrate the attachment of the step (100) to the vehicle (50) using an attachment system (10) of any type disclosed herein. In the embodiment shown in the Figures, the vehicle is a Jeep® Wrangler® or a Jeep® Gladiator® available from Stellantis N.V. of Hoofddorp, Netherlands. Such vehicles are known to include a tubular portion (51)—sometimes referred to as a rock rail—located below and exterior to the side rocker panels of the vehicle. As these tubular portions are located below and exterior to the side rocker panels of the vehicle, they are also below and exterior to the vehicle driver and passenger doors which are above the rocker panels. In certain instances, the attachment system may include one more spacers which can be added between the mounting surface of the tubular portion of the vehicle and the vehicle chassis to extend the tubular portion away from the vehicle to allow for proper clearance and alignment to attach the step to the vehicle.

As shown in FIG. 11, the step (100) is configured to attach to the vehicle (50)—at least in part—by connecting the first hook (220) to a section of the tubular portion (51). Similarly, FIG. 12 illustrates the step being configured to attach to the vehicle—at least in part—by connecting the second hook (230) to a separate section of the tubular portion. Finally, FIG. 13 illustrates the step being configured to attach to the vehicle—at least in part—by connecting the brace (300) to a threaded hole (52) in the vehicle by passing a brace fastener (330) through the first plate attachment hole ((313) as shown in FIG. 10) and into the threaded hole. In some embodiments, the threaded hole may include a factory-provided nut for connecting the rock rail to the vehicle's chassis. Preferably, the threaded hole will be an existing threaded hole in the vehicle's chassis or body. The brace may be adjusted along the length of the mounting bracket (200) as described herein with reference to FIGS. 3 and 10 so as to align the first plate attachment hole with the threaded hole.

Preferably, the step (100) will be attached to the vehicle (50) in such a way that the step is substantially aligned with at least one of the vehicles doors. In doing so, the step may be used to assist vehicle occupants in stepping into and out of the vehicle.

The various components of the attachment system and step disclosed herein—including components of the step, the mounting bracket, and the brace—may be manufactured using any number of different materials and any number of different manufacturing techniques. Preferably, the various components will be manufactured of a metal material such as steel, stainless steel, aluminum, or the like. However, embodiments may exist in which one or more of the components is manufactured of a rigid plastic material such as acrylonitrile butadiene styrene (ABS), polyethylene (PE), nylon, and the like. Manufacturing techniques may include cutting, bending, grinding, welding, casting, forging, injection molding and the like using common equipment for conducting such operations.

The embodiments of an attachment system for connecting a step to a vehicle disclosed herein represent an improvement over prior art steps and attachment systems. Specifically, the disclosed systems can be quickly and easily installed (and uninstalled if desired) to a vehicle by disposing the hooks over a tubular portion of the vehicle at or about the vehicle rocker panel below the door opening, and bolting the brace to an existing threaded hole in the underside of the vehicle chassis with minimal fasteners (only the fasteners connecting the brace to the vehicle) required during installation. In doing so, little or no permanent physical modifications to the existing vehicle structure are required—resulting in minimal impact to vehicle safety and structural integrity as well as an installed step which is aesthetically pleasing. The resulting step is structurally sound for individuals entering and exiting the vehicle as the central plate assembly—in addition to providing mounting features for connecting the step to the vehicle—also provides structural support. In addition, the plurality of first horizontal plate holes provide adjustability allowing the brace to be moved along the length of the central plate to align with existing threaded hole features in the vehicle as opposed to requiring drilling and tapping of a new hole into the vehicle.

While the attachment system for connecting a step to a vehicle has been described as having one or more exemplary designs, the present article may be further modified within the spirit and scope of this disclosure. This application is therefore intended to cover any variations, uses, or adaptations of the attachment system for connecting a step to a vehicle using their general principles.

What is claimed is:

1. An attachment system (10) for connecting a step (100) to a vehicle (50), said attachment system comprising:
the step having a step upper surface (110), a step lower surface (120), and a step interior edge (130);
a mounting bracket (200) connected to the step upper surface and/or the step lower surface along at least a portion of the step interior edge, said mounting bracket comprising:
a central plate (210) having a central plate first end (211) and a central plate second end (212) opposite the central plate first end;
a first hook (220) attached to and extending from the central plate first end; and
a second hook (230) attached to and extending from the central plate second end; and
a brace (300) attached to and extending from the central plate between the central plate first end and the central plate second end, said brace comprising:
a first member (310) having a first longitudinal plate (311) attached to and forming a first angle relative to a second longitudinal plate (312), said first angle having a first angle measurement of about 90°, at least one first plate attachment hole (313) passing through the first longitudinal plate, and a slot (314) extending from a second longitudinal plate terminal end (315) through at least a portion of the first longitudinal plate; and
a second member (320) disposed within the slot and attached to the first member wherein a second angle formed between a second longitudinal plate lower surface (316) and the second member has a second angle measurement of about 90°, and a third angle formed between a second longitudinal plate upper surface (317) and the second member has a third angle measurement of about 90°; and
wherein the first hook and the second hook are each independently configured to connect to a tubular portion (51) of the vehicle, and the brace is configured to connect to a threaded hole (52) in the vehicle by passing a brace fastener (330) through the first plate attachment hole and into the threaded hole.

2. The attachment system of claim 1, wherein the central plate includes a central plate assembly (215) comprising:
a first vertical plate (240) having a first vertical plate terminal end (241), a first vertical plate proximal end (242), a first vertical plate upper edge (243), and a first vertical plate lower edge (244) defining first vertical plate plane having an first vertical plate interior surface (245) and a first vertical plate exterior surface (246);
a second vertical plate (250) attached to and extending from the first vertical plate terminal end, said second vertical plate having a second vertical plate terminal end (251), a second vertical plate proximal end (252), a second vertical plate upper edge (253), and a second vertical plate lower edge (254) defining a second vertical plate plane having a second vertical plate interior surface (255) and a second vertical plate exterior surface (256) wherein a fourth angle formed between the first vertical plate interior surface and the second vertical plate interior surface has a fourth angle measurement in a range of between 50° and 70°;
a third vertical plate (260) attached to and extending from the first vertical plate proximal end, said third vertical plate having a third vertical plate terminal end (261), a third vertical plate proximal end (262), a third vertical plate upper edge (263), and a third vertical plate lower edge (264) defining a third vertical plate plane having a third vertical plate interior surface (265) and a third vertical plate exterior surface (266) wherein a fifth angle formed between the first vertical plate interior surface and the third vertical plate interior surface has a fifth angle measurement in a range of between 50° and 70°;
a fourth vertical plate (270) attached to and extending from the second vertical plate terminal end, said fourth vertical plate having a fourth vertical plate terminal end (271), a fourth vertical plate proximal end (272), a fourth vertical plate upper edge (273), and a fourth vertical plate lower edge (274) defining a fourth vertical plate plane having a fourth vertical plate interior surface (275) and a fourth vertical plate exterior surface (276) wherein a sixth angle formed between the second vertical plate exterior surface and the fourth vertical plate exterior surface has a sixth angle measurement in a range of between 50° and 70°;
a fifth vertical plate (280) attached to and extending from the third vertical plate terminal end, said fifth vertical plate having a fifth vertical plate terminal end (281), a fifth vertical plate proximal end (282), a fifth vertical plate upper edge (283), and a fifth vertical plate lower edge (284) defining a fifth vertical plate plane having a fifth vertical plate interior surface (285) and a fifth vertical plate exterior surface (286) wherein a seventh angle formed between the third vertical plate exterior surface and the fifth vertical plate exterior surface has a seventh angle measurement in a range of between 50° and 70°; and
a first horizontal plate (290) attached to and extending inwardly from the first vertical plate lower edge, said first horizontal plate having a first horizontal plate upper surface (291) and a first horizontal plate lower surface (292) wherein an eighth angle formed between the first vertical plate interior surface and the first horizontal plate upper surface has an eighth angle measurement of about 90°; and
wherein a first mounting tab (201) having a first mounting tab hole (202) passing therethrough is attached to and extends outwardly from the first vertical plate upper edge, the second vertical plate upper edge, or the fourth vertical plate upper edge; a second mounting tab (203) having a second mounting tab hole (204) passing therethrough is attached to and extends outwardly from the first vertical plate upper edge, the third vertical plate upper edge, or the fifth vertical plate upper edge; the first hook is attached to and extends from the fourth vertical plate upper edge; and the second hook is attached to and extends from the fifth vertical plate upper edge.

3. The attachment system of claim 1, wherein the central plate includes a plurality of central plate holes (207) disposed along a central plate length spanning from the central plate first end to the central plate second end, the second longitudinal plate includes at least one second longitudinal plate hole (318) at the second longitudinal plate terminal end, and the brace is adjustably connectable to the mounting bracket by passing a third fastener (208) through the at least one second longitudinal plate hole and into a central plate hole of the plurality of central plate holes.

4. The attachment system of claim 1, wherein the step further comprises:
a tube (140) having a tube proximal end (141), a tube terminal end (142), a tube first inward bend between the tube proximal end and the tube terminal end having a tube first inward bend angle in a range of between 50° and 70°, and a tube second inward bend between the tube first inward bend and the tube terminal end having a tube second inward bend angle in a range of between 50° and 70°;
a platform (150) having a platform proximal end (151), a platform terminal end (152), a platform exterior edge (153), and a platform interior edge (154) defining a platform plane having a platform upper surface (155) and a platform lower surface (156); and
a lip (160) attached to and extending upwardly from the platform interior edge; and
at least a portion of each of the platform proximal end, the platform terminal end, and the platform exterior edge abuts against the tube.

5. The attachment system of claim 2, wherein step comprises at least a first step mounting hole (101) and a second step mounting hole (102), and the central plate assembly is connected to the step lower surface by passing a first fastener (205) through the first step mounting hole and into the first mounting tab hole and passing a second fastener (206) through the second step mounting hole and into the second mounting tab hole.

6. The attachment system of claim 2, wherein the central plate includes a plurality of central plate holes (207) disposed along a central plate length spanning from the central plate first end to the central plate second end, the second longitudinal plate includes at least one second longitudinal plate hole (318) at the second longitudinal plate terminal end, and the brace is adjustably connectable to the mounting bracket by passing a third fastener (208) through the at least one second longitudinal plate hole and into a central plate hole of the plurality of central plate holes.

7. The attachment system of claim 2, wherein the first horizontal plate includes a plurality of first horizontal plate holes (293) disposed along a length of the first horizontal plate, the second longitudinal plate includes at least one second longitudinal plate hole (318) at the second longitudinal plate terminal end, and the brace is adjustably connectable to the mounting bracket by passing a third fastener (208) through the at least one second longitudinal plate hole and into a first horizontal plate hole of the plurality of first horizontal plate holes.

8. The attachment system of claim 2, wherein the step further comprises:
a tube (140) having a tube proximal end (141), a tube terminal end (142), a tube first inward bend between the tube proximal end and the tube terminal end having a tube first inward bend angle in a range of between 50° and 70°, and a tube second inward bend between the tube first inward bend and the tube terminal end having a tube second inward bend angle in a range of between 50° and 70°;
a platform (150) having a platform proximal end (151), a platform terminal end (152), a platform exterior edge (153), and a platform interior edge (154) defining a platform plane having a platform upper surface (155) and a platform lower surface (156); and
a lip (160) attached to and extending upwardly from the platform interior edge; and
at least a portion of each of the platform proximal end, the platform terminal end, and the platform exterior edge abuts against the tube.

9. The attachment system of claim 3, wherein the central plate includes a plurality of central plate holes (207) disposed along a central plate length spanning from the central plate first end to the central plate second end, the second longitudinal plate includes at least one second longitudinal plate hole (318) at the second longitudinal plate terminal end, and the brace is adjustably connectable to the mounting bracket by passing a third fastener (208) through the at least one second longitudinal plate hole and into a central plate hole of the plurality of central plate holes.

10. The attachment system of claim 3, wherein the first horizontal plate includes a plurality of first horizontal plate holes (293) disposed along a length of the first horizontal plate, the second longitudinal plate includes at least one second longitudinal plate hole (318) at the second longitudinal plate terminal end, and the brace is adjustably connectable to the mounting bracket by passing a third fastener (208) through the at least one second longitudinal plate hole and into a first horizontal plate hole of the plurality of first horizontal plate holes.

11. The attachment system of claim 3, wherein the step further comprises:
a tube (140) having a tube proximal end (141), a tube terminal end (142), a tube first inward bend between the tube proximal end and the tube terminal end having a tube first inward bend angle in a range of between 50° and 70°, and a tube second inward bend between the tube first inward bend and the tube terminal end having a tube second inward bend angle in a range of between 50° and 70°;
a platform (150) having a platform proximal end (151), a platform terminal end (152), a platform exterior edge (153), and a platform interior edge (154) defining a platform plane having a platform upper surface (155) and a platform lower surface (156); and
a lip (160) attached to and extending upwardly from the platform interior edge; and
at least a portion of each of the platform proximal end, the platform terminal end, and the platform exterior edge abuts against the tube.

12. The attachment system of claim 8, wherein the platform exterior edge has a platform exterior edge dimension which is less than a platform interior edge dimension of the platform interior edge.

13. The attachment system of claim 8, wherein the step further comprises:
a first step tab (170) attached to and extending inwardly from a first position on the tube, said first step tab comprising a first step tab hole (171); and
a second step tab (180) attached to and extending inwardly from a second position on the tube, said second step tab comprising a second step tab hole (181); and
wherein the platform is connected to the tube by passing a fourth fastener through a first platform mounting hole (157) and into the first step tab hole and passing a fifth fastener through a second platform mounting hole (158) and into the second step tab hole.

14. The attachment system of claim 8, wherein the tube proximal end is connected to the central plate first end.

15. The attachment system of claim 8, wherein the tube terminal end is connected to the central plate second end.

16. The attachment system of claim 8, wherein a lip proximal end (161) is connected to the central plate first end.

17. The attachment system of claim 8, wherein a lip terminal end (162) is connected to the central plate second end.

18. The attachment system of claim 8, wherein the platform exterior edge has a platform exterior edge dimension which is less than a platform interior edge dimension of the platform interior edge.

19. The attachment system of claim 11, wherein the platform exterior edge has a platform exterior edge dimension which is less than a platform interior edge dimension of the platform interior edge.

20. The attachment system of claim 12, wherein the step further comprises:
a first step tab (170) attached to and extending inwardly from a first position on the tube, said first step tab comprising a first step tab hole (171); and
a second step tab (180) attached to and extending inwardly from a second position on the tube, said second step tab comprising a second step tab hole (181); and
wherein the platform is connected to the tube by passing a fourth fastener through a first platform mounting hole (157) and into the first step tab hole and passing a fifth fastener through a second platform mounting hole (158) and into the second step tab hole.
